(19) United States
(12) Patent Application Publication
(10) Pub. No.: US 2023/0176201 A1
(43) Pub. Date: Jun. 8, 2023

(54) RELATIVE LIDAR ALIGNMENT WITH LIMITED OVERLAP

(71) Applicant: GM CRUISE HOLDINGS LLC, San Francisco, CA (US)

(72) Inventor: Alexandri Gregor Zavodny, San Francisco, CA (US)

(21) Appl. No.: 17/540,565

(22) Filed: Dec. 2, 2021

(51) Int. Cl. G01S 7/497; G01S 17/931; G01P 15/00; G01S 17/89

(52) U.S. Cl. CPC G01S 7/4972; G01S 17/931; G01P 15/00; G01S 17/89

(57) ABSTRACT

A method is provided for determining that an evaluation Light Detection and Ranging (LIDAR) on a vehicle is misaligned to a reference LIDAR on the vehicle. The method includes receiving data from successive scans performed by the reference LIDAR and an evaluation LIDAR while the vehicle is in motion and receiving vehicle odometry from accelerometers on the vehicle while performing the scans by the reference LIDAR. The method also includes determining an odometry correction from a process of aligning point clouds received as a result of the scans by the reference LIDAR. The method also includes creating a map from the process of aligning the point clouds received as the result of the scans by the reference LIDAR and determining an alignment error for the evaluation LIDAR from a process of aligning point clouds received as a result of the scans by the evaluation LIDAR to the map.

### TECHNICAL FIELD

The subject technology provides methods for aligning Light Detection and Ranging (LiDAR) sensors under evaluation with a reference LIDAR sensor on the same vehicle while there is limited overlap between the reference LIDAR sensor and other LIDAR sensors under evaluation when scanning the same scene.

### BACKGROUND

An autonomous vehicle is a motorized vehicle that can navigate without a human driver. An exemplary autonomous vehicle includes a plurality of sensor systems, such as, but not limited to, a camera sensor system, a LIDAR sensor system, a radar sensor system, amongst others, wherein the autonomous vehicle operates based upon sensor signals output by the sensor systems. Specifically, the sensor signals are provided to an internal computing system in communication with the plurality of sensor systems, wherein a processor executes instructions based upon the sensor signals to control a mechanical system of the autonomous vehicle, such as a vehicle propulsion system, a braking system, or a steering system. In some applications, these systems utilize a perception system (or perception stack) that implements various computing vision techniques to reason about the surrounding environment.

### BRIEF SUMMARY

Disclosed are systems, apparatuses, methods, computer-readable medium, and circuits for determining that an evaluation LIDAR on a vehicle is misaligned to a reference LIDAR on the vehicle. In one aspect, a method may include receiving data from successive scans performed by the reference LIDAR and an evaluation LIDAR while the vehicle is in motion; receiving vehicle odometry from accelerometers on the vehicle while performing the scans by the reference LIDAR; determining an odometry correction from a process of aligning point clouds received as a result of the scans by the reference LIDAR, wherein the amount of translation and rotation required to align the point clouds after the recorded odometry has been taken into account is reflective of the odometry correction; creating a map from the process of aligning the point clouds received as the result of the scans by the reference LIDAR; determining an alignment error for the evaluation LIDAR from a process of aligning point clouds received as a result of the scans by the evaluation LIDAR to the map, wherein the amount of translation and rotation required to align the point clouds after the recorded odometry and the odometry correction have been taken into account is reflective of the alignment error for the evaluation LIDAR to the reference LIDAR. For example, a processor receives data from successive scans performed by the reference LIDAR and an evaluation LIDAR while the vehicle is in motion; receives vehicle odometry from accelerometers on the vehicle while performs the scans by the reference LIDAR; determines an odometry correction from a process of aligns point clouds received as a result of the scans by the reference LIDAR, wherein the amount of translation and rotation required to align the point clouds after the recorded odometry has been taken into account is reflective of the odometry correction; creates a map from the process of aligns the point clouds received as the result of the scans by the reference LIDAR; determines an alignment error for the evaluation LIDAR from a process of aligns point clouds received as a result of the scans by the evaluation LIDAR to the map, wherein the amount of translation and rotation required to align the point clouds after the recorded odometry and the odometry correction have been taken into account is reflective of the alignment error for the evaluation LIDAR to the reference LIDAR.

In another aspect, a computing system is provided that includes a storage (e.g., a memory configured to store data, such as virtual content data, one or more images, etc.) and one or more processors (e.g., implemented in circuitry) coupled to the memory and configured to execute instructions and, in conjunction with various components (e.g., a network interface, a display, an output device, etc.), cause the processor to receive data from successive scans performed by the reference LIDAR and an evaluation LIDAR while the vehicle is in motion; receive vehicle odometry from accelerometers on the vehicle while perform the scans by the reference LIDAR; determine an odometry correction from a process of align point clouds received as a result of the scans by the reference LIDAR, wherein the amount of translation and rotation required to align the point clouds after the recorded odometry has been taken into account is reflective of the odometry correction; create a map from the process of align the point clouds received as the result of the scans by the reference LIDAR; determine an alignment error for the evaluation LIDAR from a process of align point clouds received as a result of the scans by the evaluation LIDAR to the map, wherein the amount of translation and rotation required to align the point clouds after the recorded odometry and the odometry correction have been taken into account is reflective of the alignment error for the evaluation LIDAR to the reference LIDAR.

Additional embodiments and features are set forth in part in the description that follows, and will become apparent to those skilled in the art upon examination of the specification or may be learned by the practice of the disclosed subject matter. A further understanding of the nature and advantages of the disclosure may be realized by reference to the remaining portions of the specification and the drawings, which forms a part of this disclosure.

### BRIEF DESCRIPTION OF THE DRAWINGS

FIG. 1 illustrates an environment that includes an autonomous vehicle in communication with a computing system according to some examples of the present technology;

FIG. 2 illustrates several LIDAR sensors, including a reference LIDAR and evaluation LIDARs on a vehicle according to some examples of the present technology;

FIG. 3 is a flowchart of a method for determining that an evaluation LIDAR on a vehicle is misaligned to a reference LIDAR on the vehicle according to some examples of the present technology;

FIG. 4 is a flowchart of a method for determining that an evaluation LIDAR on a vehicle is misaligned to a reference LIDAR on the vehicle according to some examples of the present technology;

FIG. 5A illustrates an individual LIDAR scan of the parking garage from a roof left LIDAR sensor according to some examples of the present technology;

FIG. 5B illustrates an individual LIDAR scan of the parking garage from a roof center LIDAR sensor according to some examples of the present technology;

FIG. 5C illustrates an individual LIDAR scan of the parking garage from a roof right LIDAR sensor according to some examples of the present technology;

FIG. 5D illustrates an individual LIDAR scan of a parking garage from a side left LIDAR sensor according to some examples of the present technology;

FIG. 5E illustrates an individual LIDAR scan of the parking garage from a side right LIDAR sensor according to some examples of the present technology;

FIG. 6A is a map created by accumulating scans from a reference LIDAR sensor (e.g., roof left LIDAR sensor) according to some examples of the present technology;

FIG. 6B illustrates the alignment of one individual scan as illustrated in FIG. 5A with the map of FIG. 6A according to some examples of the present technology;

FIG. 7A illustrates an enlarged image showing portions of two scans from a reference LIDAR sensor with a small odometry correction according to some examples of the present technology;

FIG. 7B illustrates an enlarged image showing portions of two scans from a reference LIDAR sensor with a large odometry correction according to some examples of the present technology;

FIG. 7C illustrates odometry corrections in rotation by using iterative closest points (ICP) to align all samples with a first sample according to some examples of the present technology;

FIG. 8A illustrates rotation variations for five samples from a side right sensor according to some examples of the present technology;

FIG. 8B illustrates rotation variations for 25-30 samples from the side right sensor of FIG. 8A according to some examples of the present technology;

FIG. 9A illustrates rotation variations for five samples from a side right sensor against a reference sensor or roof left sensor according to some examples of the present technology;

FIG. 9B illustrates rotation variations for 25-30 samples from the side right sensor against the reference sensor or roof left sensor of FIG. 9A according to some examples of the present technology; and

FIG. 10 shows an example of a system for implementing certain aspects of the present technology.

### DETAILED DESCRIPTION

The disclosed technology addresses a need to check relative extrinsic alignments of multiple LIDAR sensors under evaluation to a reference LIDAR sensor on a vehicle. The alignments can be done by projecting all the LIDAR scans into the same coordinate frame, which requires knowledge of the positions of the LIDAR sensors relative to each other.

The LIDAR data is captured over a relatively short travel distance in a constrained environment. There is a very small portion overlapping in the LIDAR scans because of different views of the same scene by the multiple LIDAR sensors and the reference LIDAR sensor when the vehicle moves relative to the target. As such, the point clouds from scanning the scene by the multiple LIDAR sensors have limited or partial overlap with the reference LIDAR sensor.

The disclosure provides a solution that builds a map of an entire scene by using a reference LIDAR sensor. When the vehicle drives in a scene or a space, the reference LIDAR sensor on the vehicle may incrementally take scans, and the scans are aligned by using an iterative closest points (ICP) algorithm. The data from the multiple LIDAR sensors can be fed into the ICP algorithm, which can be used to generate a transformation that minimizes the distance between the LIDAR scans from each of the multiple LIDAR sensors.

The disclosure provides a method that creates a map of the scene by accumulating scans from the reference LIDAR sensor and aligning scans from other LIDAR sensors with the map. The map creates larger point clouds for alignments of the LIDAR sensors under evaluation to the reference LIDAR sensor on the vehicle. The map increases the amount of data in a consistent coordinate frame and thus improves accuracy.

The disclosure also provides a method that determines odometry correction terms between successive scans from the reference LIDAR sensors and applies the odometry correction terms to the successive scans for the other LIDAR sensors under evaluation. An estimate of the vehicle odometry is obtained from accelerometers and gyroscopes on the vehicle. However, the estimate of the vehicle odometry is inaccurate, which would cause inaccuracy in building the map. A small correction may be made for each scan. The disclosure provides a method that extracts those corrections for the scans from the reference LIDAR sensor and considers those corrections to be a corrective term for the odometry on the vehicle as a whole. When aligning evaluation LIDAR sensors against that map, the odometry correction is applied to each scan. Then, the corrected scans from the evaluation LIDARs are aligned against the map. The odometry correction term helps provide more robust alignments than without the odometry corrections.

The method includes collecting a series of samples from the reference LIDAR sensor, which may be spaced based on a travel distance. Then, each of the samples from the reference LIDAR are aligned to the prior samples (in time/sequence) from the reference LIDAR, which is the process that builds the map. Once all samples from the reference LIDAR are aligned in sequence, the samples form the map. The odometry correction or correction term may be saved for each of the samples. The odometry correction can be used before aligning individual scans from evaluation LIDAR sensors on the vehicle against the map. Since the odometry correction has been applied, any additional error will most likely be due to an incorrect alignment of the evaluation LIDAR with respect to the evaluation LIDAR.

Individual scans can be taken from LIDAR sensors under evaluation, which are referred to as evaluation LIDARs. Instead of aligning the scans against individual scans from the reference LIDAR sensor, the scans from the evaluation LIDAR sensors are aligned against the map created from the reference LIDAR sensor.

The present technology provides a benefit of being able to determine likely misalignments of LIDAR on the same vehicle without needing external equipment. The present technology is able to identify LIDAR misalignment errors by comparing data from other LIDARs on the same vehicle.

A further benefit is that the present method does not require a specialized calibration scene. The present technology can be used while a vehicle with multiple LIDARs is moving in any area, including a city street. The fact that the present disclosure makes reference to a particular testing environment that may or may not have LIDAR targets does not negate the capability of the ideas described herein to be used in other environments or without particular targets.

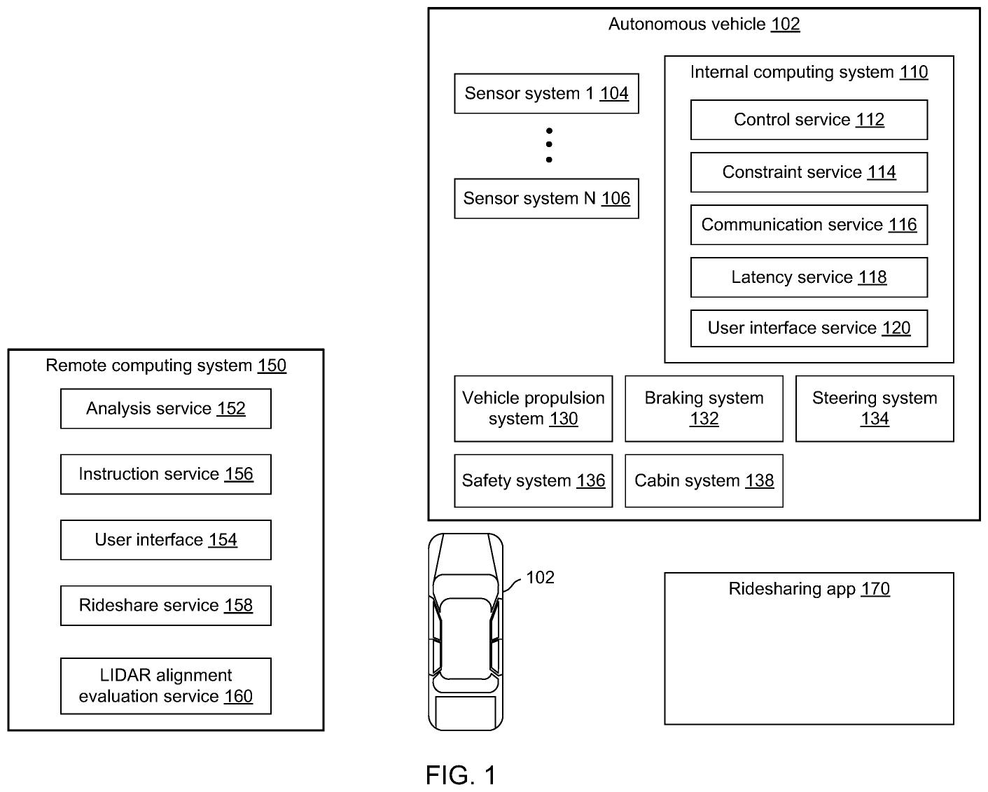

FIG. 1 illustrates environment 100 that includes an autonomous vehicle 102 in communication with a computing system 150.

The autonomous vehicle 102 can navigate about roadways without a human driver based upon sensor signals output by sensor systems 104-106 of the autonomous vehicle 102. The autonomous vehicle 102 includes a plurality of sensor systems 104-106 (a first sensor system 102 through an Nth sensor system 104). The sensor systems 104-106 are of different types and are arranged about the autonomous vehicle 102. For example, the first sensor system 104 may be a camera sensor system and the Nth sensor system 106 may be a lidar sensor system. Other exemplary sensor systems include radar sensor systems, global positioning system (GPS) sensor systems, inertial measurement units (IMU), infrared sensor systems, laser sensor systems, sonar sensor systems, and the like.

The autonomous vehicle 102 further includes several mechanical systems that are used to effectuate appropriate motion of the autonomous vehicle 102. For instance, the mechanical systems can include but are not limited to, a vehicle propulsion system 130, a braking system 132, and a steering system 134. The vehicle propulsion system 130 may include an electric motor, an internal combustion engine, or both. The braking system 132 can include an engine brake, brake pads, actuators, and/or any other suitable componentry that is configured to assist in decelerating the autonomous vehicle 102. The steering system 134 includes suitable componentry that is configured to control the direction of movement of the autonomous vehicle 102 during navigation.

The autonomous vehicle 102 further includes a safety system 136 that can include various lights and signal indicators, parking brake, airbags, etc. The autonomous vehicle 102 further includes a cabin system 138 that can include cabin temperature control systems, in-cabin entertainment systems, etc.

The autonomous vehicle 102 additionally comprises an internal computing system 110 that is in communication with the sensor systems 104-106 and the mechanical systems 130, 132, 134. The internal computing system includes at least one processor and at least one memory having computer-executable instructions that are executed by the processor. The computer-executable instructions can make up one or more services responsible for controlling the autonomous vehicle 102, communicating with remote computing system 150, receiving inputs from passengers or human co-pilots, logging metrics regarding data collected by sensor systems 104-106 and human co-pilots, etc.

The internal computing system 110 can include a control service 112 that is configured to control operation of the vehicle propulsion system 106, the braking system 108, the steering system 110, the safety system 136, and the cabin system 138. The control service 112 receives sensor signals from the sensor systems 102-104 as well communicates with other services of the internal computing system 110 to effectuate operation of the autonomous vehicle 102. In some embodiments, control service 112 may carry out operations in concert one or more other systems of autonomous vehicle 102.

The internal computing system 110 can also include a constraint service 114 to facilitate safe propulsion of the autonomous vehicle 102. The constraint service 116 includes instructions for activating a constraint based on a rule-based restriction upon operation of the autonomous vehicle 102. For example, the constraint may be a restriction upon navigation that is activated in accordance with protocols configured to avoid occupying the same space as other objects, abide by traffic laws, circumvent avoidance areas, etc. In some embodiments, the constraint service can be part of the control service 112.

The internal computing system 110 can also include a communication service 116. The communication service can include both software and hardware elements for transmitting and receiving signals from/to the remote computing system 150. The communication service 116 is configured to transmit information wirelessly over a network, for example, through an antenna array that provides personal cellular (long-term evolution (LTE), 3G, 5G, etc.) communication.

In some embodiments, one or more services of the internal computing system 110 are configured to send and receive communications to remote computing system 150 for such reasons as reporting data for training and evaluating machine learning algorithms, requesting assistance from remoting computing system or a human operator via remote computing system, software service updates, ridesharing pickup and drop off instructions etc.

The internal computing system 110 can also include a latency service 118. The latency service 118 can utilize timestamps on communications to and from the remote computing system 150 to determine if a communication has been received from the remote computing system 150 in time to be useful. For example, when a service of the internal computing system 110 requests feedback from remote computing system 150 on a time-sensitive process, the latency service 118 can determine if a response was timely received from remote computing system 150 as information can quickly become too stale to be actionable. When the latency service 118 determines that a response has not been received within a threshold, the latency service 118 can enable other systems of autonomous vehicle 102 or a passenger to make necessary decisions or to provide the needed feedback.

The internal computing system 110 can also include a user interface service 120 that can communicate with cabin system 138 in order to provide information or receive information to a human co-pilot or human passenger. In some embodiments, a human co-pilot or human passenger may be required to evaluate and override a constraint from constraint service 114, or the human co-pilot or human passenger may wish to provide an instruction to the autonomous vehicle 102 regarding destinations, requested routes, or other requested operations.

As described above, the remote computing system 150 is configured to send/receive a signal from the autonomous vehicle 140 regarding reporting data for training and evaluating machine learning algorithms, requesting assistance from remoting computing system or a human operator via the remote computing system 150, software service updates, ridesharing pickup and drop off instructions, etc.

The remote computing system 150 includes an analysis service 152 that is configured to receive data from autonomous vehicle 102 and analyze the data to train or evaluate machine learning algorithms for operating the autonomous vehicle 102. The analysis service 152 can also perform analysis pertaining to data associated with one or more errors or constraints reported by autonomous vehicle 102.

The remote computing system 150 can also include a user interface service 154 configured to present metrics, video, pictures, sounds reported from the autonomous vehicle 102 to an operator of remote computing system 150. User interface service 154 can further receive input instructions from an operator that can be sent to the autonomous vehicle 102.

The remote computing system 150 can also include an instruction service 156 for sending instructions regarding the operation of the autonomous vehicle 102. For example, in response to an output of the analysis service 152 or user interface service 154, instructions service 156 can prepare instructions to one or more services of the autonomous vehicle 102 or a co-pilot or passenger of the autonomous vehicle 102.

The remote computing system 150 can also include a rideshare service 158 configured to interact with ridesharing applications 170 operating on (potential) passenger computing devices. The rideshare service 158 can receive requests to be picked up or dropped off from passenger ridesharing app 170 and can dispatch autonomous vehicle 102 for the trip. The rideshare service 158 can also act as an intermediary between the ridesharing app 170 and the autonomous vehicle wherein a passenger might provide instructions to the autonomous vehicle 102 to go around an obstacle, change routes, honk the horn, etc.

The remote computing system 150 can also include a LIDAR alignment evaluation service 160 configured to build a map from a reference LIDAR sensor, and align LIDARs under evaluation with the reference LIDAR on the same vehicle. The LIDAR alignment evaluation service 160 is also configured to use an iterative closest point (ICP) algorithm to determine an odometry correction term from the reference LIDAR sensor and to receive the data from scans from each of the LIDAR sensors, run the data through the ICP algorithm. The odometry corrective term may be represented by six degrees of freedom, including translation coordinates x, y, z, and rotation angles roll, pitch, and yaw.

The ICP algorithm works in a following way. The ICP algorithm may tweak x, y, z slightly in sequence, and then tweak roll, pitch, and yaw separately. Then, the ICP algorithm may use the gradient information from the tweaking to try to alter the estimated transformation until the transformation reaches a local minimum.

The LIDAR alignment evaluation service 160 is also configured to check the alignment against the reference LIDAR sensor, and validate the calibration before the AV drives on the road. The LIDAR data and odometry data are collected by the internal computing system 110 on the vehicle and evaluated on the internal computing system 110 on the vehicle.

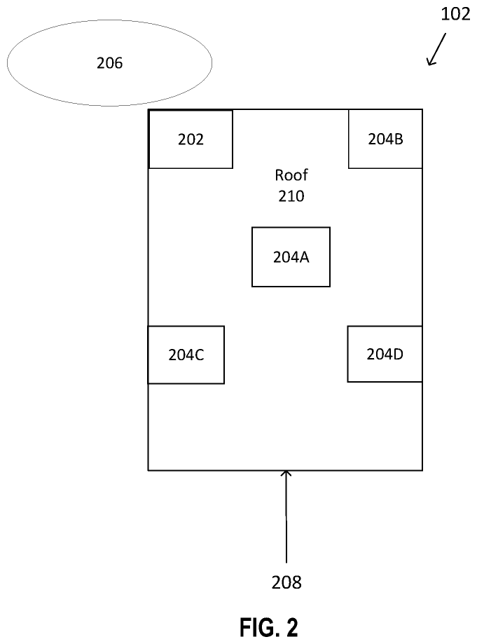

FIG. 2 illustrates five LIDAR sensors on a roof of a vehicle according to some examples of the present technology. As illustrated, one sensor 202 is positioned on the left side of the front on a roof 210 of vehicle 102, also referred to as a roof left sensor, which is assumed to be a reference LIDAR sensor. Four other sensors 204A-D are under evaluation for their alignments against the reference sensor 202. Sensor 204A is positioned on the center of the front on the roof 210 of vehicle 102 and is also referred to as a roof center sensor. Sensor 204B is positioned on the left side of the front on the roof 210 of vehicle 102. Sensors 204C and 204D are positioned on the left side and right side of the vehicle, and also referred to as a side left sensor and a side right sensor, respectively.

Vehicle 102 moves through scene 206, as illustrated by arrow 208. Structural information in scene 206 may be used to collect LIDAR data, such as ground planes, sidewalls, and ceilings, among others. The distance from the ground, sidewalls, and ceilings can be detected by the LIDAR sensors.

The front LIDAR sensors 202 and 204A-B face forward and may get a scan of the ground in front of the vehicle, including the ceiling and sidewalls. The side LIDAR sensors 204C-D are primarily for detecting obstacles in a short-range. The side LIDAR sensors 204C-D are aimed down toward the ground and may get a very high amount of visibility on the ground next to the vehicle.

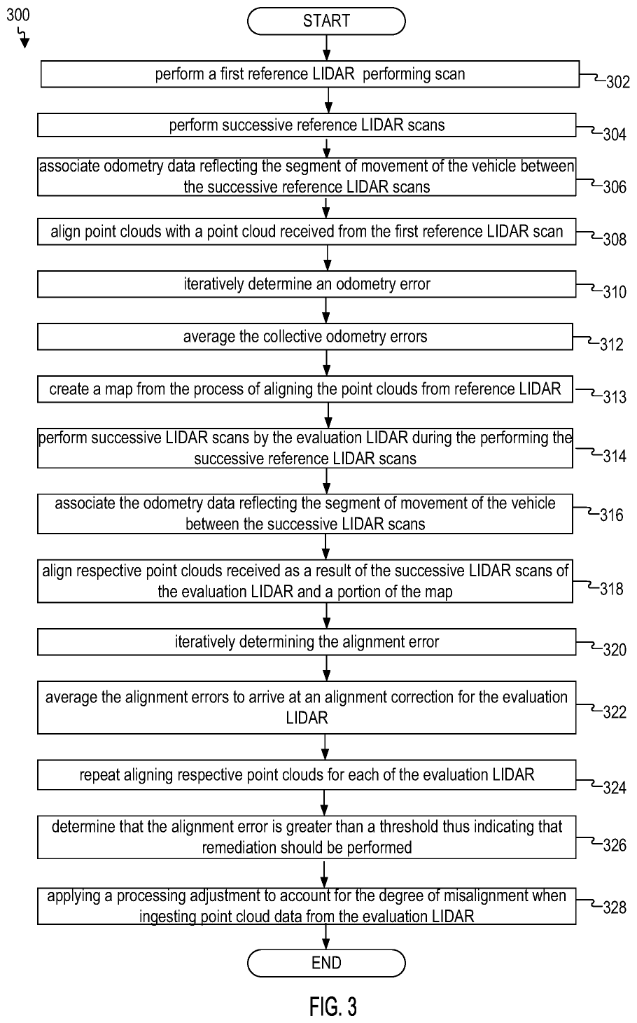

FIG. 3 illustrates an example method 300 for determining if an evaluation LIDAR on a vehicle is misaligned with respect to a reference LIDAR on the vehicle. Although example method 300 depicts a particular sequence of operations, the sequence may be altered without departing from the scope of the present disclosure. For example, some of the operations depicted may be performed in parallel or in a different sequence that does not materially affect the function of method 300. In other examples, different components of an example device or system that implements method 300 may perform functions at substantially the same time or in a specific sequence.

According to some examples, method 300 includes performing an initial reference LIDAR scan at step 302. For example, the LIDAR 202 or reference LIDAR illustrated in FIG. 2 may perform an initial reference LIDAR scan. The LIDAR scan is performed to measure distances from objects in a scene when the AV stops in the scene. In some variations, the LIDAR scan is a sweep of 360 degrees.

According to some examples, method 300 includes performing successive reference LIDAR scans at step 304. For example, the LIDAR 202 or reference LIDAR illustrated in FIG. 2 may perform successive reference LIDAR scans. There is a segment of movement of the vehicle between the successive LIDAR scans. When the AV moves a distance or the segment of, the AV stops again and the successive LIDAR scan is performed to measure distances from objects in the scene. In some variations, the LIDAR scan is a sweep of 360 degrees.

As an example, one scan or sample is taken from the reference LIDAR sensor 202 on the vehicle at a fixed travel distance, e.g., every one meter of the travel distance. Then, the consecutive samples from the reference LIDAR sensor 202 are used to build a map. For instance, a number of scans, e.g., 25 consecutive scans, are taken from roof left LIDAR sensor 202 to build the map.

According to some examples, method 300 may include associating odometry data reflecting the segment of movement of the vehicle between the successive reference LIDAR scans, the odometry data for the movement between the LIDAR scans being associated with the respective LIDAR scans occurring after the segment of movement of the vehicle at step 306. For example, the LIDAR alignment evaluation service 160 illustrated in FIG. 1 may associate odometry data reflecting the segment of movement of the vehicle between the successive reference LIDAR scans, the odometry data for the movement between the LIDAR scans is associated with the respective LIDAR scans that occur after the segment of movement of the vehicle.

According to some examples, method 300 may include aligning respective point clouds received as a result of the successive reference LIDAR scans of the reference LIDAR with a point cloud received from the first reference LIDAR scan from the reference LIDAR at step 308. For example, the LIDAR alignment evaluation service 160 illustrated in FIG. 1 may align respective point clouds received as a result of the successive reference LIDAR scans of the reference LIDAR with a point cloud received from the first reference LIDAR scan from the reference LIDAR. The LIDAR data are collected by the internal computing system 110 on the vehicle and evaluated on the computing system 110 on the vehicle.

In another example of the aligning respective point clouds at step 308, method 300 may include inputting (a) the point cloud received from the first reference LIDAR scan, (b) a first of the respective point clouds received as a result of the first of the successive reference LIDAR scans, and (c) the associated odometry data reflecting the segment of movement of the vehicle between the first LIDAR scan and the first of the successive reference LIDAR scans into an iterative closest point algorithm. For example, the LIDAR 202 illustrated in FIG. 2 may input (a) the point cloud received from the first reference LIDAR scan, (b) a first of the respective point clouds received as a result of the first of the successive reference LIDAR scans, and the sensor system (e.g. accelerometer) illustrated in FIG. 1 may input (c) the associated odometry data reflecting the segment of movement of the vehicle between the first LIDAR scan and the first of the successive reference LIDAR scans into an iterative closest point algorithm. The iterative closest point algorithm outputs the odometry error for each LIDAR scan of the reference LIDAR in 6-degrees-of-freedom (x, y, z, pitch, roll, and yaw). In some embodiments, the iterative closest point algorithm is a generalized iterative closest point algorithm.

Further, method 300 may include determining an odometry error that reflects the amount of translation and rotation that is needed to align the point cloud received from the first reference LIDAR scan and the first of the respective point clouds received as a result of the first of the successive reference LIDAR scans when taking into account the odometry data for the segment of movement of the vehicle between the first LIDAR scan and the first of the successive reference LIDAR scans. For example, the LIDAR alignment evaluation service 160 illustrated in FIG. 1 may determine an odometry error that reflects the amount of translation and rotation that is needed to align the point cloud received from the first reference LIDAR scan and the first of the respective point clouds received as a result of the first of the successive reference LIDAR scans when taking into account the odometry data for the segment of movement of the vehicle between the first LIDAR scan and the first of the successive reference LIDAR scans. The odometry error is broken into an amount of error in 6-degrees-of-freedom reflecting error in x, y, and z planes and rotation of pitch, roll, and yaw.

Further, method 300 may include inputting (iteratively) sequential point clouds from the successive reference LIDAR scans into the iterative closest point algorithm to align the sequential point clouds to the first point cloud from the first reference LIDAR scan. For example, the LIDAR alignment evaluation service 160, illustrated in FIG. 1 may input (iteratively) sequential point clouds from the successive reference LIDAR scans into the iterative closest point algorithm. The LIDAR alignment evaluation service 160 aligns the sequential point clouds to the first point cloud from the first reference LIDAR scan.

According to some examples, method 300 may include iteratively determining an odometry error that reflects the amount of translation and rotation that is needed to align the sequential point clouds to the first point cloud from the first reference LIDAR scan when taking into account the known odometry data for the segment of movement of the vehicle between a previous reference LIDAR scan of the sequential reference LIDAR scans and the next sequential reference LIDAR scan of the sequential reference LIDAR scans at step 310. For example, the LIDAR alignment evaluation service 160 illustrated in FIG. 1 may iteratively determine an odometry error that reflects the amount of translation and rotation that is needed to align the sequential point clouds to the first point cloud from the first reference LIDAR scan when taking into account the known odometry data for the segment of movement of the vehicle between a previous reference LIDAR scan of the sequential reference LIDAR scans and the next sequential reference LIDAR scan of the sequential reference LIDAR scans. The odometry error is reflection of the vehicle's actual movement that is not represented in the odometry data recorded for the movement of the vehicle.

According to some examples, method 300 may include averaging the collective odometry errors to arrive at an odometry correction at step 312. For example, the LIDAR alignment evaluation service 160 illustrated in FIG. 1 may average the collective odometry errors to arrive at an odometry correction. In some variations, the odometry error may be the error between the first scan and any of the successive scans from the reference LIDAR sensor. The odometry correction is a compensation for the odometry error and is applied to the point clouds received from the scans from the evaluation LIDAR before aligning the point clouds received from the scans of the evaluation LIDAR to the map.

According to some examples, method 400 may include creating a map from the process of aligning the point clouds received as the result of the scans by the reference LIDAR at step 313. For example, the LIDAR alignment evaluation service 160 illustrated in FIG. 1 may create a map from the process of aligning the point clouds received as the result of the scans by the reference LIDAR. The point clouds received from the reference LIDAR have limited overlap with the point clouds received from the evaluation LIDAR. The map has a large point cloud and provides a better overlap between the reference LIDAR and the evaluation LIDAR.

According to some examples, method 300 may include performing successive LIDAR scans by the evaluation LIDAR at step 314. The successive scans by the evaluation LIDAR can occur during the performing the successive reference LIDAR scans (the occur at step 304). For example, the LIDAR (e.g. 204A-D) or evaluation LIDAR illustrated in FIG. 2 may perform successive LIDAR scans during performing the successive reference LIDAR scans by the reference LIDAR. That is all of the LIDAR (both the reference LIDAR and the evaluation LIDAR) may be performing their scans at substantially the same time, but at least some iterations of steps from 306-313 should occur before iterations of step 316 or 318, which are addressed below.

As an example, one scan or sample is taken from each of the LIDAR sensors 204A-D on the vehicle simultaneously with the reference LIDAR sensor 202 at a fixed travel distance, e.g. every one meter of the travel distance. The samples from the evaluation LIDAR sensors 204A-D are used for the evaluation of the alignments to the reference LIDAR sensor 202.

For instance, each of the 25 scans from the side left LIDAR sensor 204C is aligned to the map to get an estimate of misalignment from the reference LIDAR sensor 202. This evaluation process can be repeated for each of the other LIDAR sensors 204A, 204B, and 204D. Now, 25 individual estimates of the six degrees of freedom transformation can be obtained for each of the other LIDAR sensors.

According to some examples, method 300 may include associating the odometry data reflecting the segment of movement of the vehicle between the successive LIDAR scans, the odometry data for the movement between the LIDAR scans being associated with the respective LIDAR scans occurring after the segment of movement of the vehicle at step 316. For example, the LIDAR alignment evaluation service 160 illustrated in FIG. 1 may associate the odometry data reflecting the segment of movement of the vehicle between the successive LIDAR scans, the odometry data for the movement between the LIDAR scans be associated with the respective LIDAR scans occur after the segment of movement of the vehicle.

According to some examples, method 300 may include aligning respective point clouds received as a result of the successive LIDAR scans of the evaluation LIDAR and a portion of the map at step 318. For example, the LIDAR alignment evaluation service 160 illustrated in FIG. 1 may align respective point clouds received as a result of the successive LIDAR scans of the evaluation LIDAR and a portion of the map. The point clouds received from the reference LIDAR have limited overlap with the point clouds received from the evaluation LIDAR.

In another example of the aligning respective point clouds at step 318, the method may include inputting (a) a first of the respective point clouds received as a result of the first of the successive LIDAR scans from the evaluation LIDAR, and (b) the associated odometry data reflecting the segment of movement of the vehicle between the LIDAR scans, (c) the odometry correction into the iterative closest point algorithm. For example, the evaluation LIDAR (e.g. 204A-D) illustrated in FIG. 2 may input (a) a first of the respective point clouds received as a result of the first of the successive LIDAR scans, and the sensor system on the vehicle illustrated in FIG. 1 may input (b) the associated odometry data reflecting the segment of movement of the vehicle between the LIDAR scans, (c) the odometry correction into the iterative closest point algorithm.

Method 300 may also include applying the odometry correction to the successive LIDAR scans from the evaluation LIDAR to align to the first LIDAR scan from the evaluation LIDAR.

Further, method 300 may include determining an alignment error that reflects the amount of translation and rotation that is needed to align the respective point cloud received as a result of the successive LIDAR scans with the odometry correction from the evaluation LIDAR and a portion of the map when taking into account the known odometry data for the segment of movement of the vehicle and the odometry correction. For example, the LIDAR alignment evaluation service 160 illustrated in FIG. 1 may determine an alignment error that reflects the amount of translation and rotation that is needed to align the respective point cloud received as a result of the first of the successive LIDAR scans from the evaluation LIDAR and a portion of the map when taking into account the known odometry data for the segment of movement of the vehicle and the odometry correction. The alignment error is broken into an amount of error in 6 degrees of freedom reflecting error in x, y, and z planes and rotation of pitch, roll, and yaw.

Further, method 300 may include inputting sequential point clouds from the successive evaluation LIDAR scans with odometry corrections into the iterative closest point algorithm to align the sequential point clouds to the portion of the map. For example, the evaluation LIDAR (e.g. 204 A-D) illustrated in FIG. 2 may input sequential point clouds from the successive evaluation LIDAR scans into the iterative closest point algorithm to align the sequential point clouds to the portion of the map.

According to some examples, method 300 may include iteratively determining the alignment error that reflects the amount of translation and rotation that is needed to align the sequential point clouds to the map when taking into account the known odometry data for the segment of movement of the vehicle and the odometry correction at step 320. For example, the LIDAR alignment evaluation service 160 illustrated in FIG. 1 may iteratively determine the alignment error that reflects the amount of translation and rotation that is needed to align the sequential point clouds to the map when taking into account the known odometry data for the segment of movement of the vehicle and the odometry correction.

According to some examples, method 100 may include averaging the collective alignment errors to arrive at an alignment correction for the evaluation LIDAR which reflects a degree of misalignment of the evaluation LIDAR to a reference LIDAR on the same vehicle at step 322. For example, the LIDAR alignment evaluation service 160 illustrated in FIG. 1 may average the collective alignment errors to arrive at an alignment correction for the evaluation LIDAR which reflects a degree of misalignment of the evaluation LIDAR to a reference LIDAR on the same vehicle.

According to some examples, the method 100 may include repeating the aligning respective point clouds received as a result of the successive LIDAR scans of the evaluation LIDAR and a portion of the map and the averaging the collective alignment errors to arrive at an alignment correction for the evaluation LIDAR for each of the evaluation LIDAR on the vehicle at step 324. For example, the LIDAR alignment evaluation service 160 illustrated in FIG. 1 may repeat the aligning respective point clouds received as a result of the successive LIDAR scans of the evaluation LIDAR and a portion of the map and the average the collective alignment errors to arrive at an alignment correction for the evaluation LIDAR for each of the evaluation LIDAR on the vehicle. The portion of the map may include data from the reference LIDAR and each evaluation LIDAR for which the aligning the respective point clouds to the portion of the map has already occurred. The vehicle can have multiple evaluation LIDARs. Repeating the aligning respective point clouds received as a result of the successive LIDAR scans of the evaluation LIDAR and a portion of the map can include performing the repeated aligning steps in series. The repeating the aligning respective point clouds received as a result of the successive LIDAR scans of the evaluation LIDAR and a portion of the map can include performing the repeated aligning steps concurrently.

According to some examples, method 300 may include determining that the alignment error is greater than a threshold thus indicating that remediation should be performed at step 326. This step relates to when the threshold is not met. For example, the LIDAR alignment evaluation service 160 illustrated in FIG. 1 may determine that the alignment error is greater than a threshold thus indicating that remediation should be performed. The alignment error is considered greater than the threshold when a statistically significant number of samples from the evaluation LIDAR is greater than half of a degree of alignment error.

According to some examples, method 300 may include applying a processing adjustment to account for the degree of misalignment when ingesting point cloud data from the evaluation LIDAR at step 328. For example, the internal computing system 110 illustrated in FIG. 1 may apply a processing adjustment to account for the degree of misalignment when ingesting point cloud data from the evaluation LIDAR.

According to some examples, method 300 may include realigning the evaluation LIDAR to account for the degree of misalignment. For example, a technician may realign the evaluation LIDAR to account for the degree of misalignment.

According to some examples, method 300 may be repeated with a different LIDAR designated as the reference LIDAR.

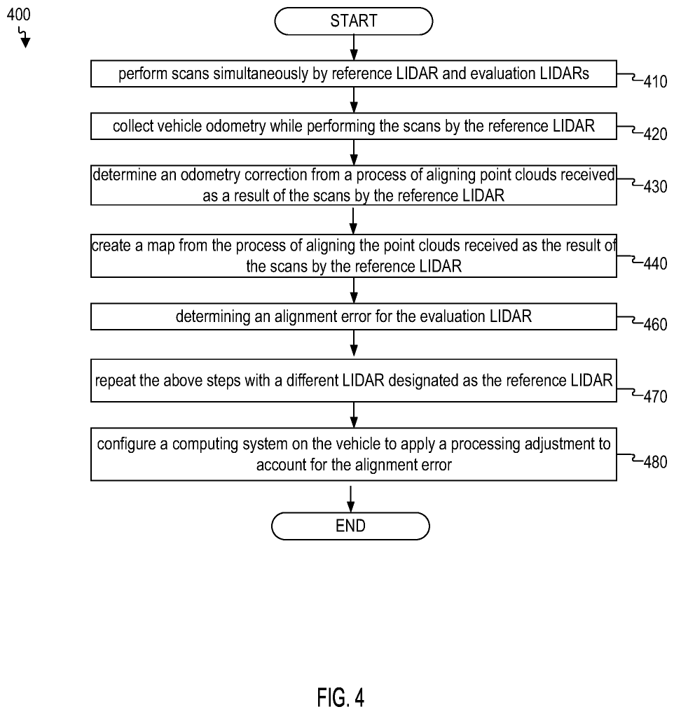

FIG. 4 illustrates an example method 400 for determining if an evaluation LIDAR on a vehicle is misaligned to a reference LIDAR on the vehicle. Although example method 400 depicts a particular sequence of operations, the sequence may be altered without departing from the scope of the present disclosure. For example, some of the operations depicted may be performed in parallel or in a different sequence that does not materially affect the function of method 400. In other examples, different components of an example device or system that implements method 400 may perform functions at substantially the same time or in a specific sequence.

According to some examples, method 400 may include performing scans simultaneously by the reference LIDAR and evaluation LIDARs while the vehicle is in motion at step 410. For example, the reference LIDAR 202 and evaluation LIDARs (e.g. 204A-D) illustrated in FIG. 2 may perform scans while the vehicle is in motion. The internal computing system 110 may receive data from successive scans performed by the reference LIDAR and an evaluation LIDAR.

According to some examples, the method may include collecting vehicle odometry while performing the scans by the reference LIDAR at step 420. For example, the sensor system illustrated in FIG. 1 may collect vehicle odometry while performing the scans by the reference LIDAR. The internal computing system 110 may also receive vehicle odometry from the sensor system (e.g. accelerometers) on the vehicle while performing the scans by the reference LIDAR.

According to some examples, the method may include determining an odometry correction or odometry correction term from a process of aligning point clouds received as a result of the scans by the reference LIDAR at step 430. For example, the LIDAR alignment evaluation service 160 illustrated in FIG. 1 may determine an odometry correction from a process of aligning point clouds received as a result of the scans by the reference LIDAR. The amount of translation and rotation required to align the point clouds after the recorded odometry has been taken into account is reflective of the odometry correction. The odometry correction term is applied to scans or samples of the reference LIDAR. Then, the scans with the odometry correction from the reference LIDAR is used to create a map.

According to some examples, method 400 may include creating a map from the process of aligning the point clouds received as the result of the scans by the reference LIDAR at step 440. For example, the LIDAR alignment evaluation service 160 illustrated in FIG. 1 may create a map from the process of aligning the point clouds received as the result of the scans by the reference LIDAR. The point clouds received from the reference LIDAR have limited overlap with the point clouds received from the evaluation LIDAR. The map has a large point cloud and provides a better overlap between the reference LIDAR and the evaluation LIDAR.

For each of the other LIDAR sensors, there may be relative misalignments to the map. To estimate the relative misalignment is by taking the individual samples (e.g. 25 samples) from the evaluation sensors and getting 25 different six degrees of freedom estimates of the relative misalignment between the other LIDAR sensor and the reference LIDAR sensor on the vehicle.

According to some examples, the method may include determining an alignment error for the evaluation LIDAR from a process of aligning point clouds received as a result of the scan by the evaluation LIDAR to the map at step 460. For example, the LIDAR alignment evaluation service 160 illustrated in FIG. 1 may determine an alignment error for the evaluation LIDAR from a process of aligning point clouds received as a result of the scan by the evaluation LIDAR to the map. The amount of translation and rotation required to align the point cloud after the recorded odometry and the odometry correction have been taken into account is reflective of the alignment error for the evaluation LIDAR to the reference LIDAR. Before aligning to the map, the odometry correction term obtained from the reference LIDAR is applied to the successive scans or samples from the evaluation LIDAR sensor. The vehicle can have multiple evaluation LIDARs. The method may include repeating the determining an alignment error for each of the evaluation LIDARs on the vehicle.

According to some examples, the method may be repeated with a different LIDAR designated as the reference LIDAR at step 470. For example, the LIDAR alignment evaluation service 160 illustrated in FIG. 1 may repeat the method 400 with a different LIDAR designated as the reference LIDAR. The process is online or on the vehicle, whereby data is collected from a computer on a vehicle and is processed on the computer on the vehicle.

According to some examples, the method may include configuring a computing system on the vehicle to apply a processing adjustment to account for the alignment error when ingesting point cloud data from the evaluation LIDAR having the alignment error at step 480. For example, the internal computing system 110 on the vehicle illustrated in FIG. 1 may be configured to apply a processing adjustment to account for the alignment error when ingesting point cloud data from the evaluation LIDAR have the alignment error. In some variations, the alignment error may be an average shift value from the reference LIDAR for each roll, pitch, and yaw based upon the successive scans for the evaluation LIDAR. The method may include applying the average shift value to the evaluation LIDAR. The alignment error may be stored on the vehicle. A consistently large signal in any one of the six degrees of freedom may be a flag with the calibration of the LIDAR sensor.

### Examples

The following examples are for illustration purposes only. It will be apparent to those skilled in the art that many modifications, both to materials and methods, may be practiced without departing from the scope of the disclosure.

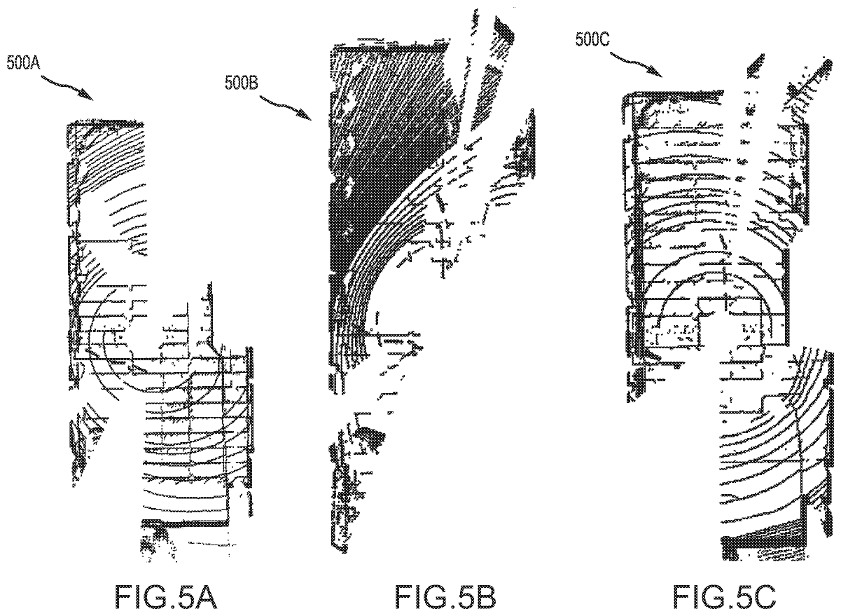

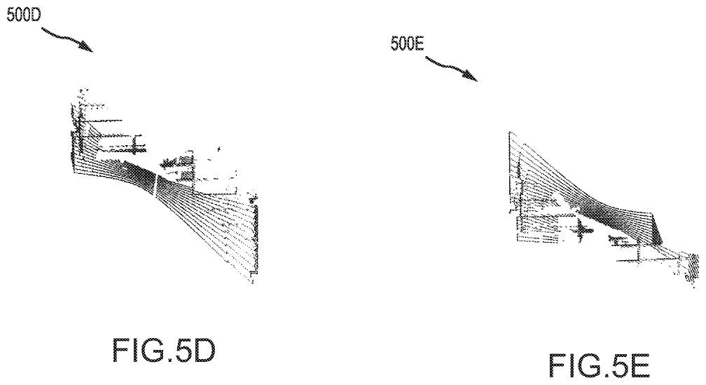

FIGS. 5A-E illustrate individual LIDAR scans of a parking garage from the five LIDAR sensors, respectively. As shown, individual scans 500A-D are collected by sensors on roof-left, roof-center, roof-right, side-left, and side-right, respectively. These individual scans 500A-D contain limited or partial overlap. As an example, vehicle 102 drives through a distance, for example, about 30 meters. LIDAR scans are taken consecutively every meter. When vehicle 102 drives in the space, the scans are taken simultaneously from the roof left LIDAR sensor 202 and other evaluation LIDAR sensors 204A-D. The LIDAR scans are reflected from objects, such as the ceiling, ground, sidewalls of the parking garage, among others.

One of the five LIDAR sensors (e.g. roof left sensor 202) is considered as a reference LIDAR sensor. All the other four sensors 204A-D are considered as evaluation LIDAR sensors, which are aligned with the reference LIDAR sensor 202. The point clouds in FIGS. 5A-E are the only visible points from each of LIDARs 202 and 204A-D on vehicle 102. Because of the limited overlap for the individual scans among the reference LIDAR sensor and the evaluation sensors, the four sensors 204A-D are aligned with the map created for the reference LIDAR sensor 202.

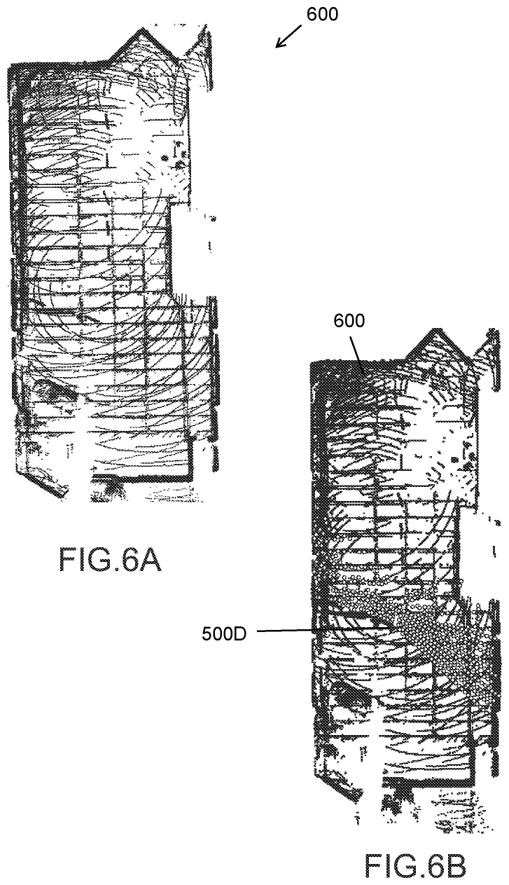

FIG. 6A is a map created by accumulating scans from a reference LIDAR sensor (e.g. roof left LIDAR sensor 202) according to some examples of the present technology. A map 600 is an overlay of the scans from the roof left LIDAR 202 (reference LIDAR). The map 600 has a much greater overlap than individual scans, for example, the individual scan illustrated in FIG. 5A from the roof left LIDAR. FIG. 6B illustrates the alignment of one individual scan 500D as illustrated in FIG. 5D with the map of FIG. 6A according to some examples of the present technology.

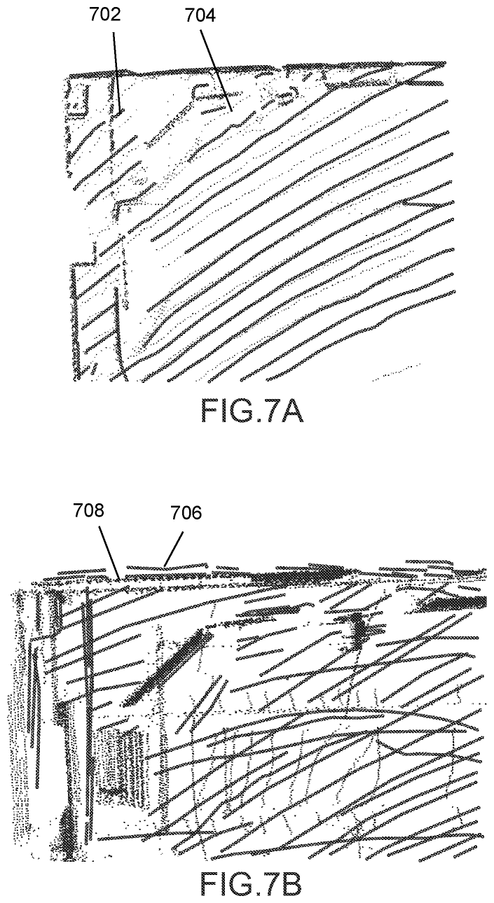

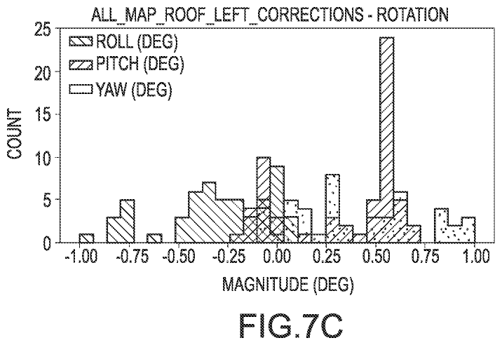

FIG. 7A illustrates an enlarged image showing portions of two scans from a reference LIDAR sensor with a small odometry correction according to some examples of the present technology. The odometry is data about movement of the vehicle. Pattern 702 in small circles represents an earlier sample or scan at the start of the drive from the reference sensor, while pattern 704 in solid circles is a scan or sample after driving for a small distance from. The double images are created due to the odometry error. When aligning the scans, the known odometry of the vehicle is used to adjust the placement of the second scan onto the map. If one has the exact knowledge about how the vehicle moves through space, the alignment of the two scans would be perfect. As referenced herein, it is impractical to determine perfect odometry data, so small discrepancies between the measured odometry of the vehicle and the actual odometry of the vehicle exist. These discrepancies result in misalignments between successive LIDAR scans when they are applied to the map. For this reason, the present technology includes a method to determine an odometry correction value to compensate for the small discrepancies between the measured odometry of the vehicle and the actual odometry. The odometry correction combined with the measured odometry data can result in better alignment of successive LIDAR scans when applied to the map.

As illustrated in FIG. 7A, there was a small misalignment between two scans, which was a result of odometry errors. When applying the odometry correction term, the alignment between the two scans became much closer.

The odometry corrections may vary. FIG. 7B illustrates an enlarged image showing portions of two scans from a reference LIDAR sensor with a large odometry correction according to another example of the instant disclosure. Pattern 706 in small circles represents an earlier sample or scan at the start of the drive from the reference sensor, while pattern 708 in solid circles is a scan or sample after driving for a large distance from the reference sensor. As illustrated in FIG. 7B, there was a large misalignment between two scans, which was a result of odometry errors.

FIG. 7C illustrates odometry corrections in rotation by using iterative closest points (ICP) to align all samples to a first sample according to some examples of the present technology. The odometry corrections are obtained for scans from the reference LIDAR sensor. Each of the successive scans includes an odometry correction from the first scan at the start of the drive. The odometry corrections in rotation can be quite large. For example, as illustrated in FIG. 7C, the roll varied from −1.00 degrees to 0 degrees. The pitch varied from −0.25 degrees to 0.60 degrees. The yaw varied from 0 to 1.00 degrees.

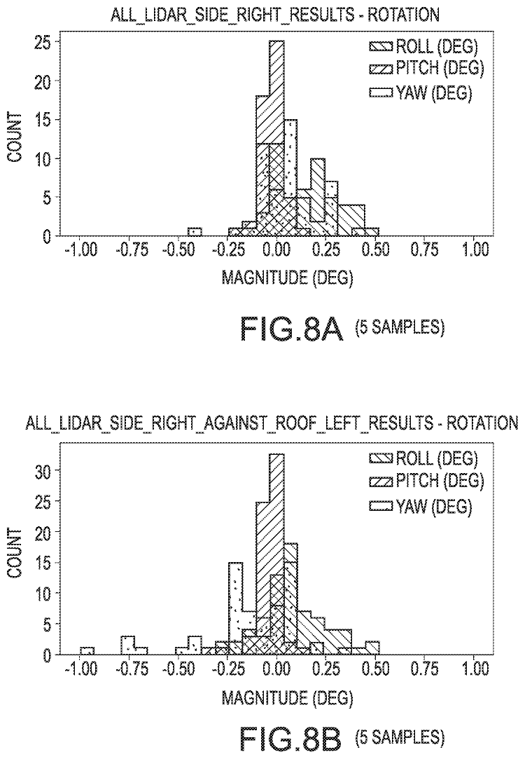

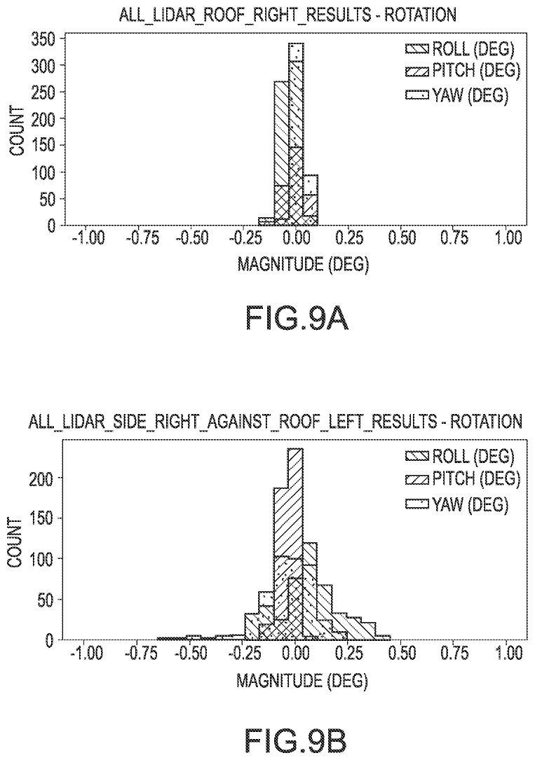

FIGS. 8A-8B and 9A-9B show that rotation variations also vary with sample size. For data collection, the vehicle drove slowly, for example, at a speed less than 0.2 m/s. The LIDAR sensors on the vehicle took samples when stopped for a short period of time, for example, stopping for 1 second. The vehicle took five samples in one drive for a distance from one end to another end, for example, 15 meters. The vehicle also took about 25 to 30 samples for the same distance in another drive. The LIDAR sensors took samples spaced a small distance (e.g. 0.5 meters apart in travel distance).

FIG. 8A illustrates rotation variations for five samples from the side right sensor according to some examples of the present technology. FIG. 8B illustrates rotation variations for 25-30 samples from the side right sensor of FIG. 8A according to some examples of the present technology. As shown in FIGS. 8A and 8B, the larger number of samples (e.g. 25-30 samples) yielded slightly smaller variations than the smaller number of samples (e.g. 5 samples).

FIG. 9A illustrates rotation variations for five samples from the side right sensor against the reference sensor or roof left sensor according to some examples of the present technology. FIG. 9B illustrates rotation variations for 25-30 samples from the side right sensor against the reference sensor or roof left sensor of FIG. 9A according to some examples of the present technology. Again, as shown in FIGS. 9A and 9B, the larger number of samples (e.g. 25-30 samples) yielded slightly smaller variations than the smaller number of samples (e.g. five samples). Compared FIG. 9A with 8A for the same number of samples (e.g. five samples), the alignment with the reference sensor revealed a slightly different distribution. Also, compared FIG. 9B with 8B for the same number of samples (e.g. 25-30 samples), the alignment with the reference sensor revealed a slightly different distribution.

An average for each roll, pitch, and yaw in FIG. 9B may be obtained for the distribution. If the average is not zero, the evaluation LIDAR may have a misalignment with respect to the reference LIDAR. Any outliers and noise may be removed according to distributions, such as those illustrated in FIGS. 8A-8B and 9A-9B. If the average for the evaluation LIDAR sensors is large, the misalignment between the reference LIDAR and the evaluation LIDAR sensors may need to be corrected. If the reference LIDAR has a calibration issue, there may be a shift in all the evaluation sensors in the same direction. The shift values may be stored and used for correction. In some aspects, distributions may be obtained for x, y, and z coordinates. Shift values from the reference LIDAR may be obtained.

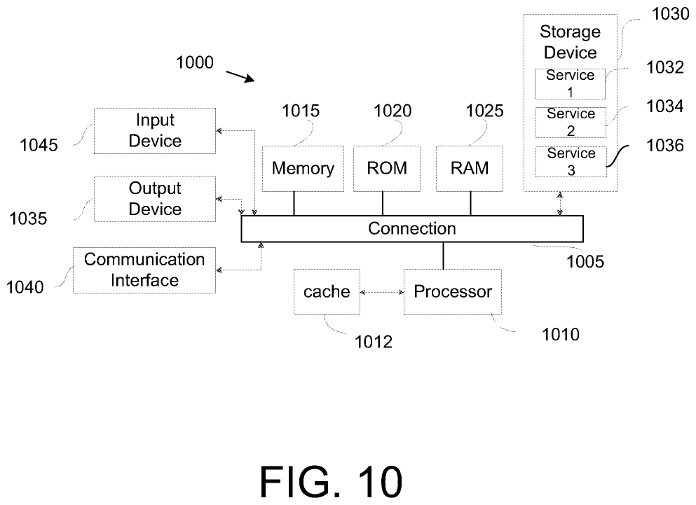

In some aspects, the misalignment may be corrected by a combination of hardware corrections and software corrections. FIG. 10 shows an example of computing system 1000, which can be for example any computing device making up internal computing system 110, or the remote computing system 150, or any component thereof in which the components of the system are in communication with each other using connection 1005. Connection 1005 can be a physical connection via a bus, or a direct connection into processor 1010, such as in a chipset architecture. Connection 1005 can also be a virtual connection, networked connection, or logical connection.

In some embodiments, computing system 1000 is a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

Example system 1000 includes at least one processing unit (CPU or processor) 1010 and connection 1005 that couples various system components including system memory 1015, such as read-only memory (ROM) 1020 and random-access memory (RAM) 1025 to processor 1010. Computing system 1000 can include a cache of high-speed memory 1012 connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms known to those of skill in the art. In some instances, multimodal systems can enable a user to provide multiple types of input/output to communicate with computing system 1000. Computing system 1000 can include communications interface 1040, which can generally govern and manage the user input and system output. There is no restriction on operating on any particular hardware arrangement, and therefore the basic features here may easily be substituted for improved hardware or firmware arrangements as they are developed.

Storage device 1030 can be a non-volatile memory device and can be a hard disk or other types of computer-readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1030 can include software services, servers, services, etc., that when the code that defines such software is executed by the processor 1010, it causes the system to perform a function. In some embodiments, a hardware service that performs a particular function can include the software component stored in a computer-readable medium in connection with the necessary hardware components, such as processor 1010, connection 1005, output device 1035, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

In some variations, the iterative closest point algorithm is a generalized iterative closest point algorithm.

In some variations, the odometry error is broken into an amount of error in 6-degrees-of-freedom reflecting error in x, y, and z planes and rotation of pitch, roll, and yaw.

In some variations, the alignment error is broken into an amount of error in 6 degrees of freedom reflecting error in x, y, and z planes and rotation of pitch, roll, and yaw.

In some variations, the vehicle can have multiple evaluation LIDARs, the method comprising repeating the aligning respective point clouds received as a result of the successive LIDAR scans of the evaluation LIDAR and a portion of the map and the averaging the collective alignment errors to arrive at an alignment correction for the evaluation LIDAR for each of the evaluation LIDAR on the vehicle.

In some variations, repeating the aligning respective point clouds received as a result of the successive LIDAR scans of the evaluation LIDAR and a portion of the map can include performing the repeated aligning steps in series. The portion of the map includes data from the reference LIDAR.

In some variations, repeating the aligning respective point clouds received as a result of the successive LIDAR scans of the evaluation LIDAR and a portion of the map can include performing the repeated aligning steps concurrently.

In some variations, when each of the multiple evaluation LIDARs all have a statistically significant alignment error, the reference LIDAR is misaligned.

In some variations, the method may include determining that the alignment error is greater than a threshold, thus indicating that remediation should be performed.

In some variations, the alignment error is considered greater than the threshold when a statistically significant number of samples from the evaluation LIDAR is greater than half of a degree of alignment error.

In some variations, the method may include realigning the evaluation LIDAR to account for the degree of misalignment.

In some variations, the method may include applying a processing adjustment to account for the degree of misalignment when ingesting point cloud data from the evaluation LIDAR.

In some variations, the reference LIDAR can be any LIDAR on the vehicle.

In some variations, a different LIDAR can be designated as the reference LIDAR.

In some variations, the point clouds received from the reference LIDAR have limited overlap with the point clouds received from the evaluation LIDAR.

In some variations, the iterative closest point algorithm outputs the odometry error for each LIDAR scan of the reference LIDAR in 6-degrees-of-freedom (x, y, z, pitch, roll, and yaw).

In some variations, the iterative closest point algorithm outputs the alignment error for each LIDAR scan of the evaluation LIDAR in 6-degrees-of-freedom (x, y, z, pitch, roll, and yaw).

In some variations, the odometry error is a reflection of the vehicle's actual movement that is not represented in the odometry data for the movement of the vehicle.

In some variations, the odometry correction is a compensation for the odometry error that is applied to the point clouds received from the scans from the evaluation LIDAR when aligning the point clouds received from the scans of the evaluation LIDAR to the map.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for determining that an evaluation Light Detection and Ranging (LIDAR) on a vehicle is misaligned to a reference LIDAR on the vehicle, the method comprising:
receiving data from successive scans performed by the reference LIDAR and the evaluation LIDAR while the vehicle is in motion;
receiving vehicle odometry from accelerometers on the vehicle while performing the scans by the reference LIDAR;
determining an odometry correction from a process of aligning point clouds received as a result of the scans by the reference LIDAR, wherein an amount of translation and rotation required to align the point clouds after the recorded odometry has been taken into account is reflective of the odometry correction;
creating a map from the process of aligning the point clouds received as the result of the scans by the reference LIDAR; and
determining an alignment error for the evaluation LIDAR from a process of aligning point clouds received as a result of the scans by the evaluation LIDAR to the map, wherein the amount of translation and rotation required to align the point clouds after the recorded odometry and the odometry correction have been taken into account is reflective of the alignment error for the evaluation LIDAR to the reference LIDAR.

2. The method of claim 1, wherein the point clouds received from the reference LIDAR have partial overlap with the point clouds received from the evaluation LIDAR.

3. The method of claim 1, wherein the vehicle comprises a plurality of evaluation LIDARs, the method comprising repeating the determining an alignment error for the evaluation LIDAR for each of the plurality of evaluation LIDARs on the vehicle.

4. The method of claim 1, further comprising:
configuring a computing system on the vehicle to apply a processing adjustment to account for the alignment error when ingesting point cloud data from the evaluation LIDAR having the alignment error.

5. The method of claim 4, wherein the alignment error comprises an average shift value from the reference LIDAR for one or more of roll, pitch and yaw based upon the successive scans for the evaluation LIDAR, the method comprising applying the average shift value to the evaluation LIDAR.

6. The method of claim 1, further comprising:
repeating the method of claim 1 with a different LIDAR designated as the reference LIDAR.

7. The method of claim 1, wherein the method is an online process, wherein the data is collected from a computing system on the vehicle and evaluated on the computing system on the vehicle.

8. A system comprising:
a storage configured to store instructions;
a processor configured to execute the instructions and cause the processor to:
receive data from successive scans performed by the reference LIDAR and an evaluation LIDAR while the vehicle is in motion,
receive vehicle odometry from accelerometers on the vehicle while perform the scans by the reference LIDAR,
determine an odometry correction from a process of align point clouds received as a result of the scans by the reference LIDAR, wherein the amount of translation and rotation required to align the point clouds after the recorded odometry has been taken into account is reflective of the odometry correction,
create a map from the process of align the point clouds received as the result of the scans by the reference LIDAR, and
determine an alignment error for the evaluation LIDAR from a process of align point clouds received as a result of the scans by the evaluation LIDAR to the map, wherein the amount of translation and rotation required to align the point clouds after the recorded odometry and the odometry correction have been taken into account is reflective of the alignment error for the evaluation LIDAR to the reference LIDAR.

9. The system of claim 8, wherein the point clouds received from the reference LIDAR have partial overlap with the point clouds received from the evaluation LIDAR.

10. The system of claim 8, wherein the vehicle comprises a plurality of evaluation LIDARs, wherein the alignment error is determined for each of the plurality of evaluation LIDARs on the vehicle.

11. The system of claim 8, wherein the processor is configured to execute the instructions and cause the processor to:
configure a computing system on the vehicle to apply a processing adjustment to account for the alignment error when ingesting point cloud data from the evaluation LIDAR have the alignment error.

12. The system of claim 11, wherein the alignment error comprises an average shift value from the reference LIDAR for each of roll, pitch and yaw based upon the successive scans for the evaluation LIDAR, the method comprising applying the average shift value to the evaluation LIDAR.

13. The system of claim 8, wherein the processor is configured to execute the instructions and cause the processor to designate a different LIDAR designated as the reference LIDAR.

14. The system of claim 8, wherein the data is collected from the computing system on the vehicle and evaluated on the computing system on the vehicle .

15. A non-transitory computer-readable medium comprising instructions, the instructions, when executed by a computing system, cause the computing system to:
receive data from successive scans performed by the reference LIDAR and an evaluation LIDAR while the vehicle is in motion;
receive vehicle odometry from accelerometers on the vehicle while perform the scans by the reference LIDAR;
determine an odometry correction from a process of align point clouds received as a result of the scans by the reference LIDAR, wherein the amount of translation and rotation required to align the point clouds after the recorded odometry has been taken into account is reflective of the odometry correction;
create a map from the process of align the point clouds received as the result of the scans by the reference LIDAR; and
determine an alignment error for the evaluation LIDAR from a process of align point clouds received as a result of the scans by the evaluation LIDAR to the map, wherein the amount of translation and rotation required to align the point clouds after the recorded odometry and the odometry correction have been taken into account is reflective of the alignment error for the evaluation LIDAR to the reference LIDAR.

16. The computer-readable medium of claim 15, wherein the point clouds received from the reference LIDAR have partial overlap with the point clouds received from the evaluation LIDAR.

17. The computer-readable medium of claim 15, wherein the vehicle comprises a plurality of evaluation LIDARs, wherein the alignment error is determined for each of the plurality of evaluation LIDARs on the vehicle.

18. The computer-readable medium of claim 15, wherein the computer-readable medium further comprises instructions that, when executed by the computing system, cause the computing system to:
configure a computing system on the vehicle to apply a processing adjustment to account for the alignment error when ingesting point cloud data from the evaluation LIDAR have the alignment error.

19. The computer-readable medium of claim 18, wherein the alignment error comprises an average shift value from the reference LIDAR for each of roll, pitch and yaw based upon the successive scans for the evaluation LIDAR, wherein the average shift value is applied to the evaluation LIDAR.

20. The computer readable medium of claim 15, wherein the data is collected from the computing system on the vehicle and evaluated on the computing system on the vehicle.
